(19) United States
(12) Patent Application Publication
(10) Pub. No.: US 2008/0174735 A1
(43) Pub. Date: Jul. 24, 2008

(54) Projection Display with Holographic Screen

(75) Inventors: Cang V. Quach, Milpitas, CA (US); William Glaser, Berkeley, CA (US)

Correspondence Address: PATENT LAW GROUP LLP, 2635 NORTH FIRST STREET, SUITE 223, SAN JOSE, CA, 95134, US

(73) Assignee: EMISCAPE, INC., San Francisco, CA (US)

(21) Appl. No.: 11/626,247

(22) Filed: Jan. 23, 2007

(51) Int. Cl. G03B 31/00; G03B 21/14

(52) U.S. Cl. 353/15

(57) ABSTRACT

A projection display system includes (1) a polarizer, (2) a holographic screen with holographic optical elements having the properties of a display portion and a polarizing portion, and (3) a projector for projecting an image through the polarizer and onto the holographic screen. The polarizing portion of the holographic screen has a different polarization direction from the polarizer such that the image is visible from a first side of the holographic screen and invisible from a second side of the holographic screen.

### CROSS REFERENCE TO RELATED APPLICATION

This application is related to U.S. patent application Ser. No. 11/109,543, entitled “Polarized Projection Display,” filed on Apr. 18, 2005, and U.S. patent application Ser. No. 11/367,687, entitled “One-Way Transparent Display Systems,” filed on Mar. 3, 2006, which are incorporated herein by reference.

### FIELD OF INVENTION

This invention relates to displays, and specifically to transparent displays with an image that is visible from one side of the display but not the other.

### DESCRIPTION OF RELATED ART

Generally speaking, advertising is the paid promotion of goods, services, companies and ideas by an identified sponsor. Advertisements on the sides of buildings were common in the early-20th century U.S. One modern example is the NASDAQ sign at the NASDAQ Market Site at 4 Times Square on 43rd Street. Unveiled in January 2000, it cost $37 million to build. The sign is 120 feet high and is the largest LED display in the world. NASDAQ pays over $2 million a year to lease the space for this sign. This is considered a good deal in advertising as a result of the number of “impressions” the sign makes far exceeds those generated by other ad forms. However, advertisements on the side of a building cover up what otherwise would be space for windows in the building.

Thus, what is needed is an apparatus that would provide advertisements on the side of buildings while still allowing for windows in the advertisement space.

### SUMMARY

In one embodiment of the invention, a projection display system includes (1) a polarizer, (2) a holographic screen with holographic optical elements having the properties of a display portion and a polarizing portion, and (3) a projector for projecting an image through the polarizer and onto the screen. The polarizer and the polarizing portion of the holographic screen have orthogonal polarization directions so that the projected image is visible from a first side of the holographic screen and invisible from a second side of the holographic screen. Because no light can pass through both polarizers, the holographic screen frees a person on the second side of the screen from any distraction caused by the image while still allowing that person to look through and see objects on the other side of the screen.

### BRIEF DESCRIPTION OF THE DRAWINGS

FIG. 1 illustrates a polarized front-projection system in one embodiment of the invention.

FIG. 2 illustrates a polarized rear-projection system in one embodiment of the invention.

FIGS. 3 and 4 illustrate views through a projection screen of the systems in FIGS. 1 and 2 in embodiments of the invention.

FIGS. 5, 6, 7, 8, and 9 illustrate various applications of the systems in FIGS. 1 and 2 in embodiments of the invention.

FIG. 10 illustrates a polarized rear-projection system in one embodiment of the invention.

FIG. 11 illustrates a polarized rear-projection system in another embodiment of the invention.

FIG. 12 illustrates an electronic device with an imaging sensor behind a one-way semi-permeable screen in one embodiment of the invention.

FIGS. 13A and 13B illustrate an augmented reality display with a one-way semi-permeable screen in one embodiment of the invention.

FIG. 14 illustrates a head-up display with a one-way semi-permeable screen in one embodiment of the invention.

Use of the same reference numbers in different figures indicates similar or identical elements.

### DETAILED DESCRIPTION

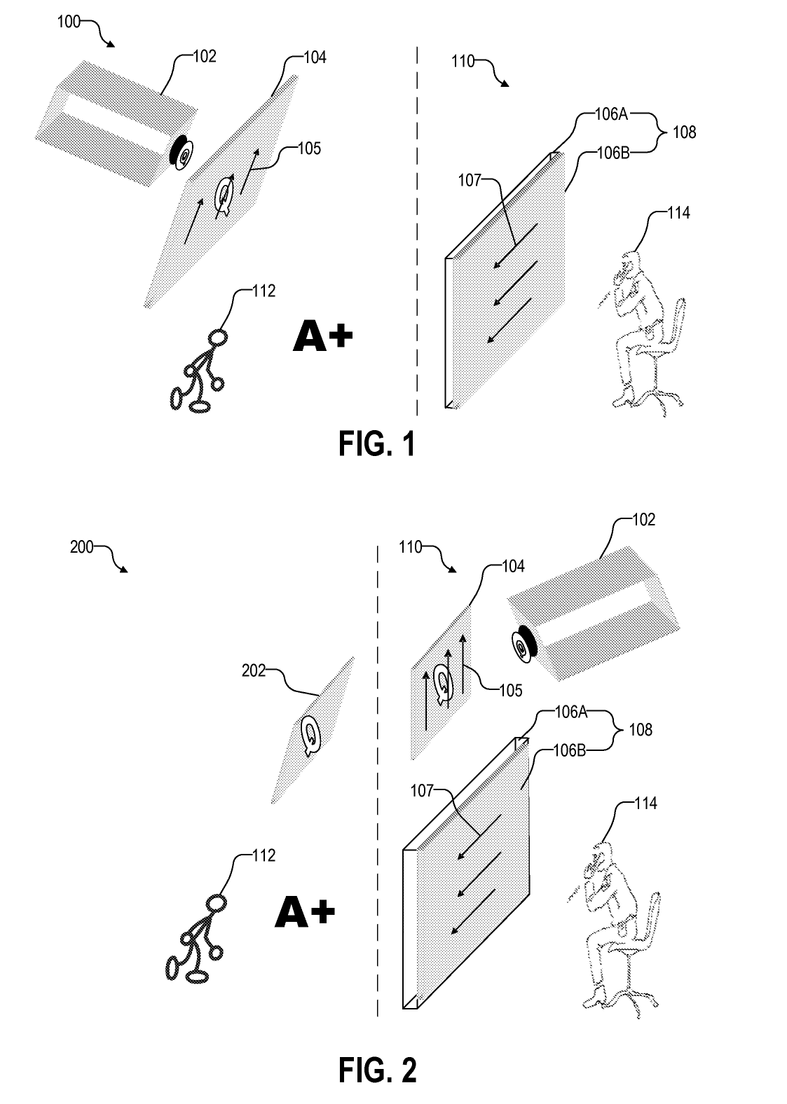

FIG. 1 illustrates a polarized front-projection system 100 in one embodiment of the invention. System 100 includes a projector 102 that generates an image “Q.” Projector 102 may be a liquid crystal display (LCD) projector, a digital light processing (DLP) projector, a laser projector, a slide projector, or any device capable of projecting an image. Depending on the application, image Q may be a still advertisement, a slideshow of still advertisements, a video advertisement, or virtually any image.

Image Q propagates through a polarizer 104 having a polarization direction 105. In one embodiment, polarizer 104 is a polarizing film near the lens of projector 102. After passing through polarizer 104, image Q only has light aligned along polarization direction 105. Alternatively, projector 102 can generate an image Q that is already polarized along direction 105.

Image Q then propagates onto a semi-permeable screen 108. Semi-permeable screen 108 includes a display portion 106A that reflects and/or scatters part of the incident light back in the direction of an intended viewer 112. Optically following display portion 106A, screen 108 includes a polarizing portion 106B with a polarization direction 107 different from polarization direction 105 so that image Q cannot propagate through polarizing portion 106B. Thus, image Q is visible on the front of screen 108 and invisible on the back of screen 108. Polarizing portion 106B may polarize light by absorption, scattering, reflection, refraction, or other polarization methods.

In one embodiment, display portion 106A is a holographic film. The holographic film includes many holographic optical elements that redirect light in different directions to viewer 112. Examples of the holographic film include HoloPro™ from G+B pronova Gmbh of Germany, and Holo Screen™ from dnp denmark of Denmark. In this embodiment, polarizing portion 106B may be a polarizer integrated into holographic film 106A by conventional holographic techniques so there is a single holographic film 108 that has both the properties of display portion 106A and the polarizing portion 106B. Alternatively, polarizing portion 106B may a polarizer film mounted to the backside of holographic film 106A.

In one embodiment, display portion 106A is an optical film or coating. Examples of optical coatings include partially reflecting or partially scattering material deposited on a clear substrate, such as glass. Alternatively, the coating could be fully reflecting or fully scattering, but then deposited to partially cover the substrate. In this embodiment, polarizing portion 106B may be a polarizer film mounted to the backside of display portion 106A. Alternatively, polarizing portion 106B can serve as the substrate on which the coating is deposited.

In one embodiment, display portion 106A is a perforated one-way vision film. The perforated film may have a highly reflective (e.g., white) front surface and an absorptive, dark, or antireflective (e.g., black) back surface. Examples of the perforated film include many of the one-way vision film used in window graphics. The highly reflective front surface improves the visibility of an image projected on the front surface while the absorptive, dark, or anti-reflective back surface increases the contrast of the view through the screen. In this embodiment, polarizing portion 106B may be a polarizer film mounted to the backside of display portion 106A. Alternatively, polarizing portion 106B may be integrated into the backside of display portion 106A by holographic, laser printing, or cutting techniques.

In one embodiment, display portion 106A is a magnesium film. The magnesium film emits visible light in response to absorption of ultraviolet light from projector 102. An example of the magnesium film is TransPlay™ from Superimaging Inc. of Fremont, Calif. In this embodiment, polarizing portion 106B may be a polarizer film mounted to the backside of display portion 106A. Alternatively, polarizing portion 106B may be integrated into the backside of display portion 106A by holographic, laser printing, or cutting techniques.

In one embodiment, semi-permeable screen 108 is placed on a window or a glass door on the side of an office building 110. Thus, viewer 112 sees image Q projected onto screen 108 while an office worker 114 does not see image Q from within the office. Office worker 114 does see other objects that are outside of the building and illuminated by non-polarized light, such as object “A+.” Overall, a large image Q can be projected onto the side of office building 110 without disturbing the office workers within while still providing a view of the outside to the office workers.

FIG. 2 illustrates a polarized rear-projection system 200 in one embodiment of the invention. System 200 is similar to system 100 except that projector 102 is now placed behind semi-permeable screen 108. In one embodiment, projector 102 is placed within office building 110 to prevent theft and damage. A projection mirror 202 is provided to reflect image Q onto screen 108.

Projector 102 generates image Q, which propagates through a polarizer 104 so that only light aligned along polarization direction 105 remains in image Q. Image Q then travels to the exterior of office building 110 and reflects from projection mirror 202 onto semi-permeable screen 108. As described above, image Q cannot propagate through polarizing portion 106B so it becomes visible on the front of screen 108 and invisible on the back of screen 108.

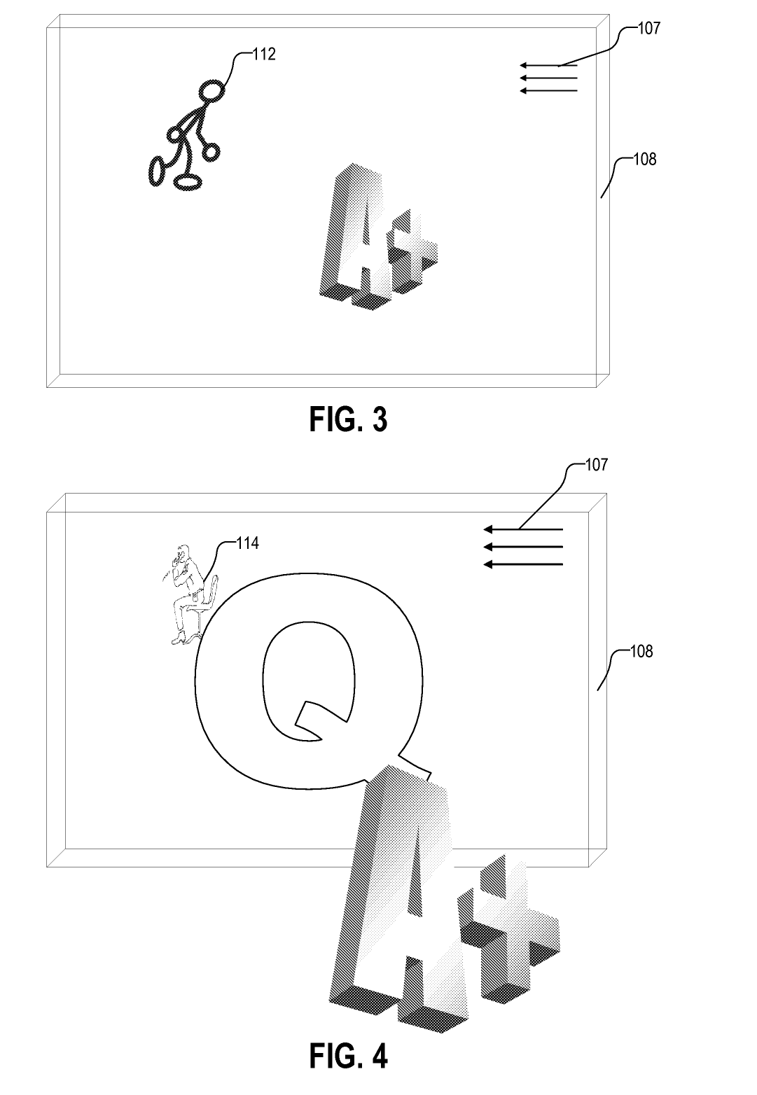

FIG. 3 illustrates the view provided to office worker 114 in one embodiment. As can be seen, office worker 114 sees object A+ through semi-permeable screen 108 but not image Q on screen 108. FIG. 4 illustrates the view provided to viewer 112 in one embodiment. As can be seen, viewer 112 sees object A+, office worker 114 through screen 108, and image Q on screen 108.

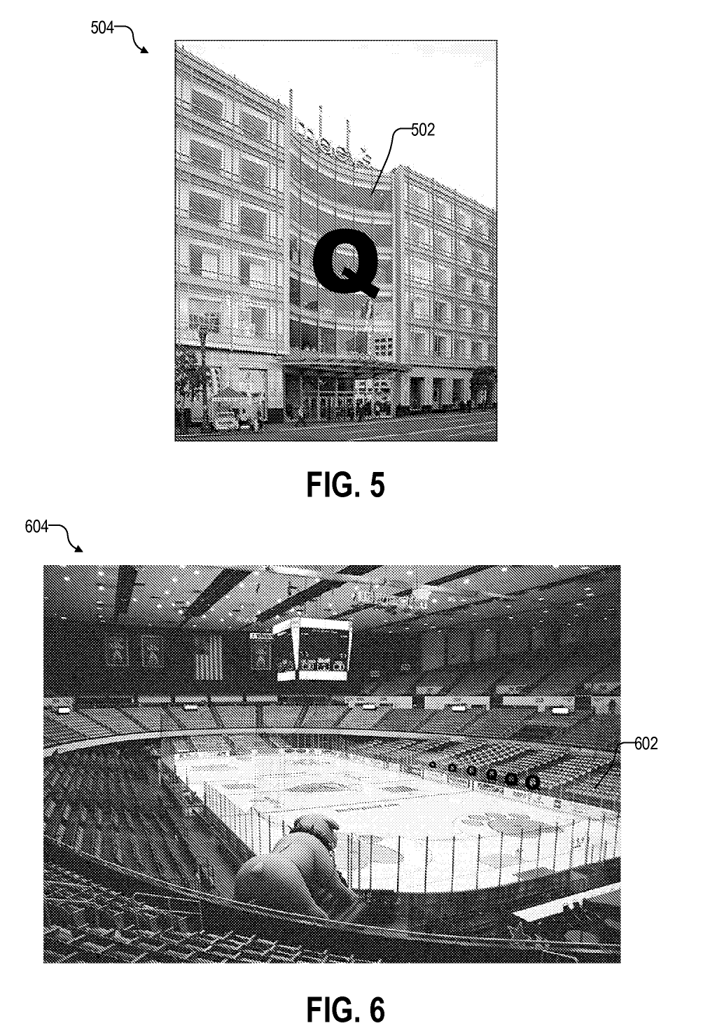

Using systems 100 and 200, any window or transparent surface can be made into a screen. There are many applications for projection systems 100 and 200. FIG. 5 shows systems 100 and 200 used to project image Q onto windows 502 of a building 504 in one embodiment. In this application, passersby see image Q (e.g., a large advertisement) but the workers inside building 504 are not disturbed by image Q and continue to enjoy their view to the outside.

FIG. 6 shows that systems 100 and 200 can be used to project multiple images Q (e.g., multiple advertisements) onto protective glass 602 of a stadium 604 in one embodiment. In this application, the audience sees through protective glass 602 directly before them to view the game but also sees images Q on protective glass across and besides them. Furthermore, television cameras capture images Q for advertisement purposes.

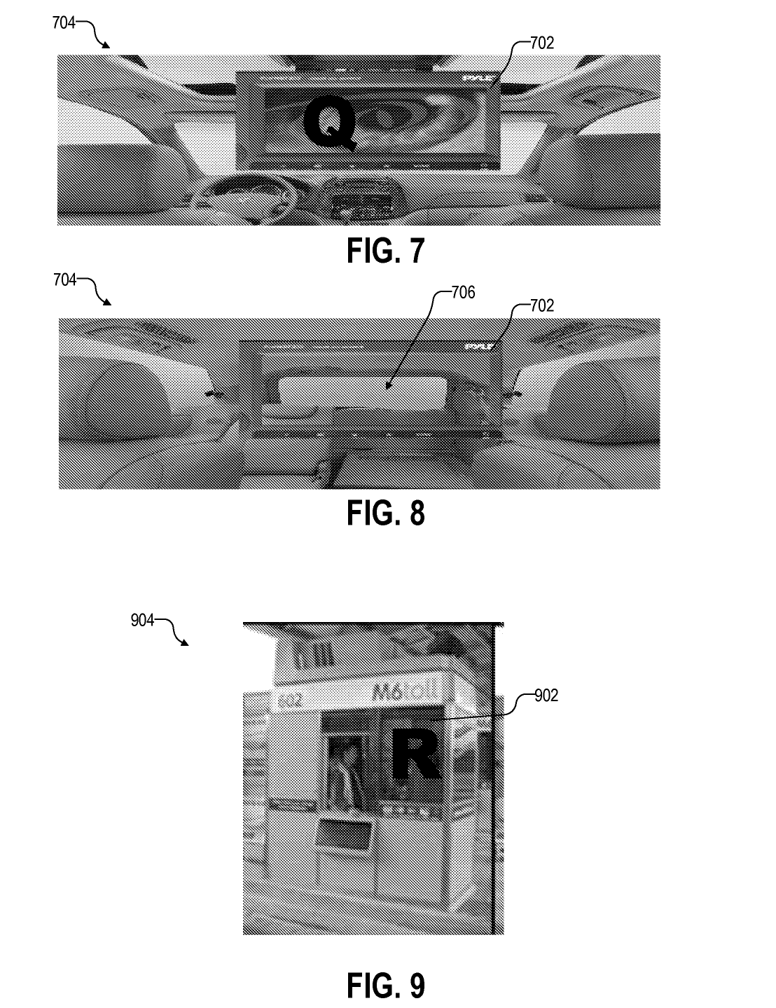

FIGS. 7 and 8 show that systems 100 and 200 can be used to project image Q on a monitor 702 for a motor vehicle 704 in one embodiment. In this application, the rear passengers see image Q on monitor 702 while the driver sees through monitor 702 and out of a rear windshield 706. Thus, monitor 702 can be made larger than conventional monitors because it does not obstruct the view of the driver. In one embodiment, the front windshield of motor vehicle 704 is polarized differently from the polarization of monitor 702 so that external light sources, such as the sun during sunrise or sunset, do not propagate pass the front windshield and through monitor 702. This embodiment prevents external light sources from interfering with image Q on monitor 702.

FIG. 9 shows that systems 100 and 200 can be used to project an image R (e.g., a toll amount) on a window 902 of a toll booth 904 in one embodiment. In this application, image R on window 902 is visible to the drivers without obstructing the toll taker's view through window 902.

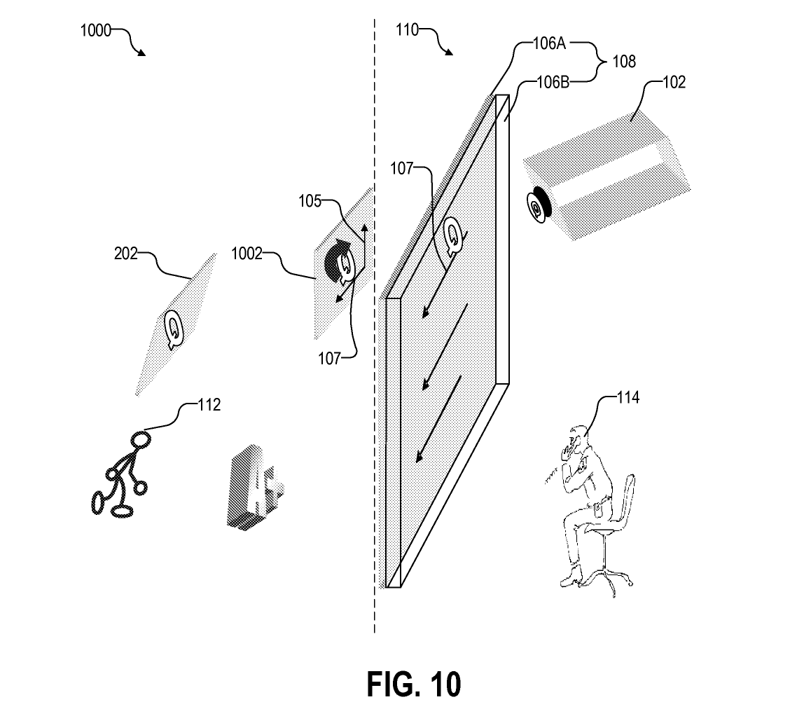

FIG. 10 illustrates a polarized rear-projection system 1000 in one embodiment of the invention. Projector 102 projects image Q through polarizer portion 106B of semi-permeable screen 108. After propagating through polarizer portion 106B, image Q only has light aligned along polarization direction 107.

Image Q then propagates through display portion 106A of semi-permeable screen 108 and onto a retarder plate 1002. Retarder plate 1002 changes the light polarization from direction 107 to direction 105. In one embodiment, retarder plate 1002 is a half-wave plate that orthogonally rotates the polarization direction of image Q.

Image Q then reflects from projection mirror 202 back onto display portion 106A. A portion of light for image Q propagates onto polarizer portion 106B of semi-permeable screen 108. As polarizer portion 106B has polarization direction 107 different from polarization direction 105, light from image Q cannot propagate through polarizer 106B. Thus, image Q is visible on a first side of screen 108 and invisible on a second side of screen 108. System 1000 can be used in various application described above.

In system 1000, a small image Q may be visible on semi-permeable screen 108 to office worker 114. This occurs when projector 102 projects images with randomly polarized light that is partly transmitted through polarizer portion 106B and partly reflected by polarizer portion 106B. The small reflected image Q can be avoided by using an LCD projector 102 that produces images with light aligned along polarization direction 107. Alternatively, an additional polarizer having polarization direction 107 can be placed near the lens of projector 102.

Furthermore, instead of using a half-wave plate 1002 that orthogonally rotates the polarization direction of image Q, a quarter-wave plate 1002 may be mounted on or integrated into projection mirror 202 so that image Q is rotated orthogonally after being reflected by mirror 202 and passing twice through plate 1002. In one embodiment, mirror 202 and quarter-wave plate 1002 are incorporated into a single holographic film by conventional holographic techniques so the holographic film has the properties of the mirror and the quarter-wave plate.

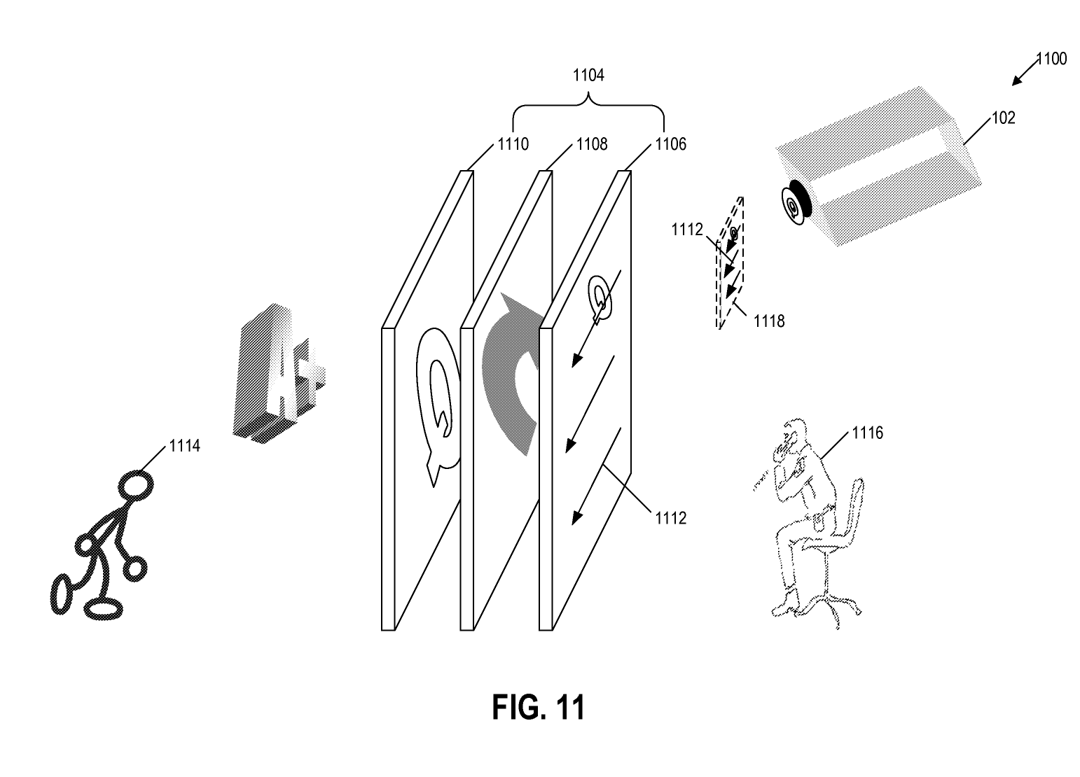

FIG. 11 illustrates a rear-projection transparent display system 1100 in one embodiment of the invention. Projector 102 generates image “Q” and projects it onto a projection screen 1104.

Projection screen 1104 includes a polarizer 1106, a retarder plate 1108, and a semi-permeable screen 1110. In one embodiment, polarizer 106, retarder plate 1108, and semi-permeable screen 1110 are separate elements. In another embodiment, polarizer 106, retarder plate 1108, and semi-permeable screen 1110 are incorporated into a single holographic film by conventional holographic techniques so the holographic film has the properties of the polarizer, the retarder plate, and the semi-permeable screen.

Image Q propagates from projector 102 through polarizer 1106. After passing through polarizer 1106, image Q is made up of substantially polarized light. In one embodiment, polarizer 1106 is a linear polarizer and image Q only has linearly polarized light aligned along a first direction 1112. Polarizer 1106 may polarize light by absorption, scattering, reflection, refraction, or other polarizing methods. When implemented as an individual component, polarizer 1106 may be a polarizing film, a polarizing film between glass panels, or an optical element implemented in a holographic plate.

Image Q then propagates through retarder plate 1108 and strikes semi-permeable screen 1110. In one embodiment, retarder plate 1108 is a quarter-wave plate. When image Q strikes semi-permeable screen 1110, it becomes visible on both sides of the screen. In one embodiment, semi-permeable screen 1110 is a transparent diffusion screen such as the HoloPro™ from G+B pronova GmbH of Germany, the Holo Screen™ from dnp denmark of Denmark, the TransPlay™ from SuperImaging of Fremont, Calif., or the TransScreen™ from Laser Magic of Los Angeles, Calif.

Any light that travels back from semi-permeable screen 1110 through retarder 1108 becomes linearly polarized along a second direction orthogonal to the first direction 1112 and is therefore subsequently blocked by polarizer 1106. Thus, image Q is visible from one side of projection screen 1104 to viewer 1114 and invisible from the other side of projection screen 1104 to worker 1116.

In system 1100, a small image Q may be visible on projection screen 1104 to worker 1116. This occurs when projector 102 projects images with non-polarized light that is partly transmitted through polarizer 1106 and partly reflected by polarizer 1106. The small reflected image Q can be avoided by using a projector 102, such as an LCD projector, that produces images with light aligned along polarization direction 1112. Alternatively, an optional polarizer 1118 having polarization direction 1112 can be placed before or on the lens of projector 102.

Although a linear polarizer and a quarter-wave plate are specifically mentioned above, polarizer 1106 and retarder 1108 may have different polarizing characteristics as long as polarizer 1106 blocks out any return light from image Q.

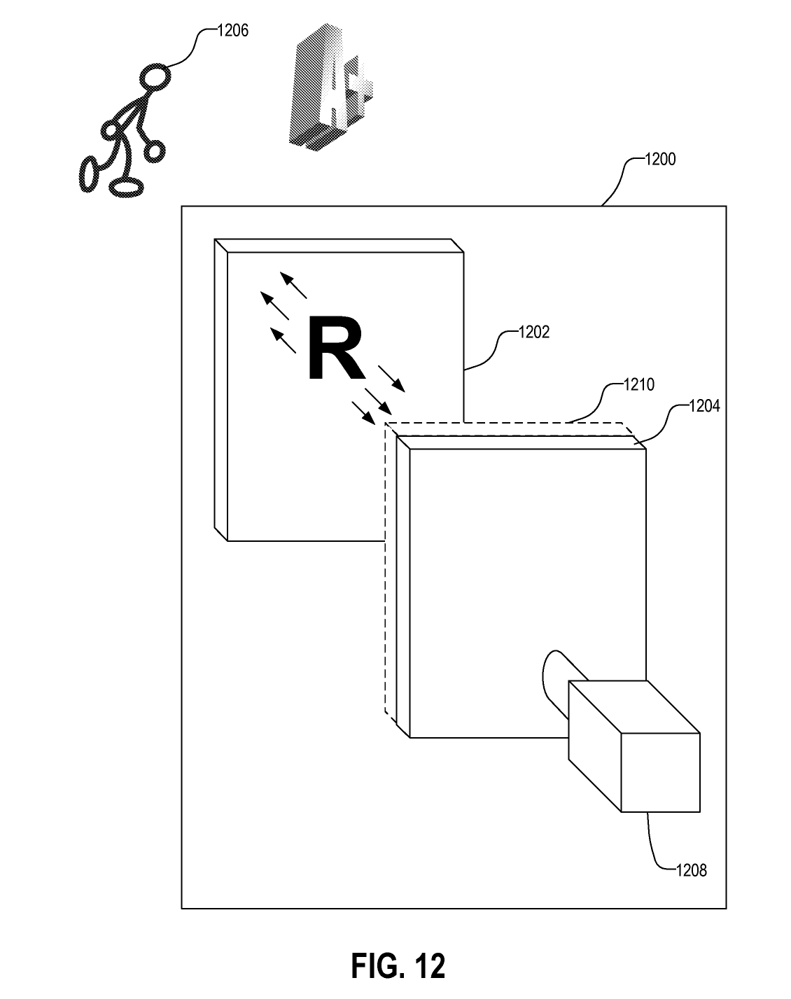

FIG. 12 illustrates a system 1200 utilizing a one-way display in one embodiment of the invention. System 1200 may be a cell phone, personal data assistant, a laptop computer, a teleprompter, or other electronic systems. Alternatively, system 1200 consists of components that are physically separated from each other and do not form a single device. System 1200 includes a transparent display 1202 and a polarizer 1204. Although shown apart, transparent display 1202 and polarizer 1204 may be mounted directly on each other.

Transparent display 1202 has a transparent screen that generates an image “R” that is visible from both sides of the display. Image R consists of polarized light that propagates away from both sides of transparent display 1202. Depending on the application, image R can be a still image, a slideshow of still images, a video stream, or virtually any image.

In one embodiment, transparent display 1202 is a transparent organic light-emitting diode (OLED) display that emits linearly polarized light. An example of a transparent OLED display is the TOLED® from Universal Display Corporation of Ewing, N.J. An example of an organic OLED that emits polarized light is described in “Polarized Emission of PPV Oligomers” by Lauhof et al., 2005 Conference of German Liquid Crystal Society.

Some of the linearly polarized light of image R propagates from transparent display 1202 to polarizer 1204, which blocks the linearly polarized light from traveling any further. Thus, image R is visible on the exterior side of transparent display 1202 but image R is invisible from the interior side of polarizer 1204. In one embodiment, this allows a user 1206 exterior to system 1200 to see image R but prevents an imaging sensor 1208 (e.g., a camera) interior to polarizer 1204 from capturing image R. Polarizer 1204 may polarize light by absorption, scattering, reflection, refraction, or other polarizing methods. Polarizer 1204 may be a polarizing film, a polarizing film between glass panels, or an optical element implemented in a holographic plate.

As described above, user 1206 viewing device 1200 from the exterior sees image R while imaging sensor 1208 within device 1200 does not see image R. This allows imaging sensor 1208 to capture images exterior to device 1200 (e.g., user 1206 and surrounding “A+”) without image R. Imaging sensor 1208 may be used in many applications, including capturing photos and videos, and videoconferencing.

In one embodiment, a one-way vision film 1210 is inserted between transparent display 1202 and polarizer 1204. One-way vision film 1210 allows imaging sensor 1208 to look out through the display of device 1200 but does not allow user 1206 to look through the display and into device 1200. In one embodiment, one-way vision film 1210 is a perforated film having a highly reflective (e.g., white) side facing transparent display 1202 and an absorptive, dark, or antireflective (e.g., black) side facing polarizer 1204.

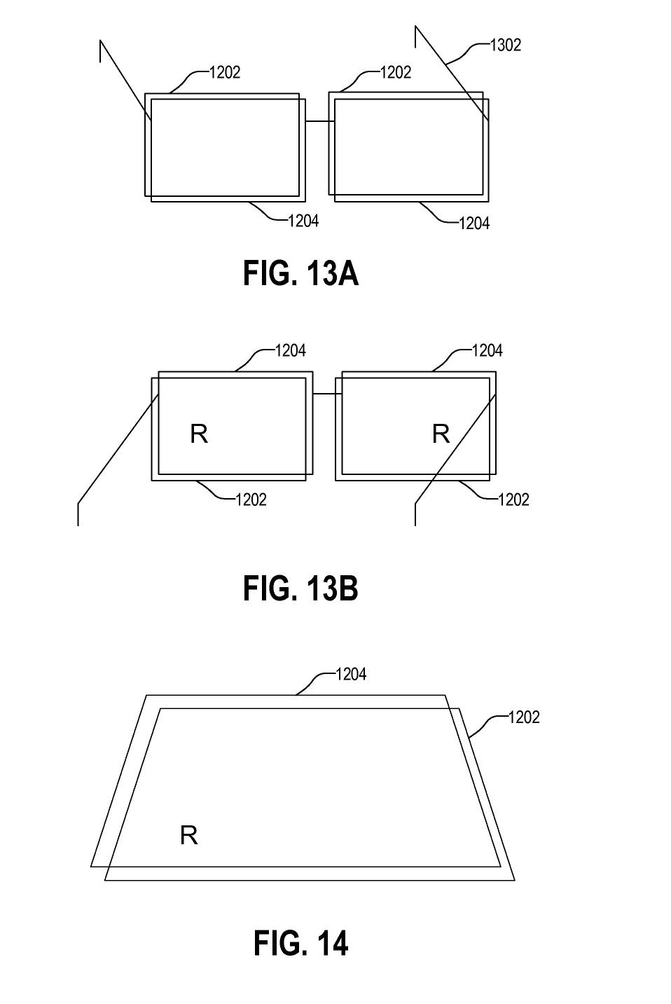

FIGS. 13A and 13B illustrate views of an augmented reality display 1300 utilizing a one-way display in one embodiment of the invention. Specifically, FIG. 13A illustrates a view looking at display 1300 while FIG. 13B illustrates a view looking out through display 1300. Display 1300 may have the form factor of a pair of glasses, a goggle, a helmet, or other type of wearable display. Display 1300 includes transparent display 1202 and polarizer 1204 mounted to a frame 1302. Transparent display 1202 is located interior relative to the wearer while polarizer 1204 is located exterior relative to the wearer. Alternatively the placement of transparent display 1202 and polarizer 1204 are reversed for fashion purposes.

As described above, transparent display 1202 has a transparent screen that generates a polarized image “R” that is visible from both sides of the display. Some of the linearly polarized light of image R propagates from transparent display 1202 to polarizer 1204, which blocks the linearly polarized light from traveling any further. Thus, image R is visible on one side of display 1300 to the wearer but image R is invisible from the other side of display 1300 to others. This way only the wearer can see the information being displayed.

FIG. 14 illustrates a head-up display 1400 utilizing a one-way display in one embodiment of the invention. Display 1400 includes transparent display 1202 and polarizer 1204. Transparent display 1202 is located interior relative to the driver while polarizer 1204 is located exterior relative to the driver. Transparent display 1202 and polarizer 1204 may be mounted on a vehicle's windshield or be integrated into the vehicle's windshield.

As described above, transparent display 1202 has a transparent screen that generates a polarized image “R” that is visible from both sides of the display. Some of the linearly polarized light of image R propagates from transparent display 1202 to polarizer 1204, which blocks the linearly polarized light from traveling any further. Thus, image R is visible on the interior side of display 1400 to the driver but image R is invisible from the exterior side of display 1400 to others. This way only the driver can see the information being displayed. Alternatively, the display side of display 1400 can be positioned on the outside for advertising purposes.

Various other adaptations and combinations of features of the embodiments disclosed are within the scope of the invention. Numerous embodiments are encompassed by the following claims.

1. A projection display system, comprising:
a polarizer for passing light of a first polarization direction;
a holographic screen comprising holographic elements for:
redirecting an image projected on the holographic screen out from at least a first side of the holographic screen;
passing light having a second polarization direction different from the first polarization direction so the image is not visible from a second side of the holographic screen; and
a projector for projecting the image through the polarizer and onto the holographic screen, wherein the image is visible from the first side of the holographic screen and invisible from a second side of the holographic screen.

2. The system of claim 1, wherein the holographic screen comprises one of a window of a building, a protective glass in a stadium, a monitor inside a motor vehicle, a window of a toll booth, a store display, and an electronic display device.

3. The system of claim 1, wherein the projector and the polarizer are located on the first side of the screen.

4. The system of claim 1, further comprising a mirror for reflecting the image from the projector onto the holographic screen, wherein the projector is located on the second side of the holographic screen and the mirror is located on the first side of the holographic screen.

5. The system of claim 1, wherein is the second polarization direction is substantially orthogonal to the first polarization direction.

6. A method for projecting an image on a holographic screen so the image is visible from a first side of the holographic screen but invisible from a second side of the holographic screen, the method comprising:
polarizing the image from a projector with a polarizer so the image has light of substantially one polarization; and
projecting the image onto the holographic screen to utilize holographic elements for:
redirecting the image out from the first side of the holographic screen; and
preventing light of said one polarization from passing so the image is not visible from the second side of the holographic screen.

7. The method of claim 6, wherein the holographic screen comprises one of a window of a building, a protective glass in a stadium, a monitor inside a motor vehicle, a window of a toll booth, a store display, and an electronic display device.

8. The method of claim 6, wherein the projector and the polarizer are located on the first side of the screen.

9. The method of claim 6, wherein said projecting the image onto the holographic screen comprises reflecting the image onto holographic screen with a mirror.

10. The method of claim 6, wherein polarization directions of the polarizer and the polarizing portion of the holographic screen are substantially orthogonal.

11. A projection display system, comprising:
a semi-permeable screen selected from the group consisting of:
a holographic screen having holographic optical elements for redirecting an image to a first side of the semi-permeable screen and for passing light of a first polarizing direction so the image is not visible from a second side of the holographic screen;
a perforated screen with mechanical perforations and a polarizer on the perforated screen for passing light of the first polarizing direction;
an optical screen with one of an optical film and an optical coating, and the polarizer on the optical screen; and
a magnesium screen with a magnesium film and the polarizer;
a retarder plate optically following the holographic screen on the first side of the semi-permeable screen;
a mirror optically following the retarder plate on the first side of the semi-permeable screen; and
a projector on a second side of the semi-permeable screen, wherein:
the projector projects an image through the semi-permeable screen, the retarder plate, and onto the mirror; and
the mirror reflects the image back onto the semi-permeable screen so that the reflected image is visible from the first side of the semi-permeable screen and invisible from the second side of the semi-permeable screen.

12. The system of claim 11, wherein the semi-permeable screen is one of a window of a building, a protective glass in a stadium, a monitor inside a motor vehicle, a window of a toll booth, a store display, and an electronic display device.

13. The system of claim 11, wherein the retarder is a half-wave plate and the image only passes once through the retarder.

14. The system of claim 11, wherein the retarder is selected from the group consisting of a quarter-wave plate mounted on the mirror and a quarter-wave plate integrated with the mirror, and the image passes twice through the retarder.

15. A method for projecting an image on a semi-permeable screen so the image is visible from a first side of the screen but invisible from a second side of the screen, the method comprising:
projecting the image through the semi-permeable screen, wherein the semi-permeable screen is selected from the group consisting of:
a holographic screen with holographic optical elements for redirecting an image to a first side of the semi-permeable screen and passing light of a first polarizing direction so the image is not visible from a second side of the semi-permeable screen;
a perforated screen with mechanical perforations and a polarizer on the perforated screen for passing light of the first polarizing direction;
an optical screen with one of an optical film and an optical coating, and the polarizer on the optical screen; and
a magnesium screen with a magnesium film and the polarizer on the magnesium screen;
passing the image through a retarder plate after the semi-permeable screen, wherein the retarder plate rotates polarization of the image; and
reflecting the image back onto the polarizer on the screen, wherein the image is visible on the first side of the semi-permeable screen and invisible on the second side of the semi-permeable screen.

16. The method of claim 15, wherein the screen is one of a window of a building, a protective glass in a stadium, a monitor inside a motor vehicle, a window of a toll booth, a store display, and an electronic display device.

17. The method of claim 15, wherein the retarder is a half-wave plate and the image only passes once through the retarder.

18. The method of claim 15, wherein the retarder is selected from the group consisting of a quarter-wave plate mounted on the mirror and a quarter-wave plate integrated with the mirror, and the image passes twice through the retarder.

19-46. (canceled)
